(19) United States
(12) Patent Application Publication
(10) Pub. No.: US 2005/0203885 A1
(43) Pub. Date: Sep. 15, 2005

(54) System and method for storing, creating, and organizing financial information electronically

(75) Inventors: William Chenevich, Portland, OR (US); Linda K. Garner, Cincinnati, OH (US); Gary Lynn Hodge, Minneapolis, MN (US); Lakhbir Lamba, Lakeville, MN (US); Andrew J. Lang, Lake Oswego, OR (US); Jon D. Rundquist, Chisago City, MN (US); Paige White Vinall, Minneapolis, MN (US)

Correspondence Address: FOLEY & LARDNER, 150 EAST GILMAN STREET, P.O. BOX 1497, MADISON, WI, 53701-1497, US

(73) Assignee: U.S. Bank Corporation

(21) Appl. No.: 10/799,378

(22) Filed: Mar. 12, 2004

(51) Int. Cl. G06F 7/00

(52) U.S. Cl. 707/3

(57) ABSTRACT

A system and/or method which offers customer-driven aggregation of data, with the ability to dynamically modify the filing hierarchy and to store, create and organize digital financial information. The system enables customers to establish a hierarchy of file folders, file any payment whether paper or electronic in a folder for future reference, provide secure storage for an indefinite period for any payment, including credit card payments, debit card transactions, imaged checks, electronic bill payments or account statements. As such, customers can create and change at will their file folder hierarchy and file documents with notes. Customers can set a preference for automatic filing based on pre-established criteria such as folders based standard merchant categories or by month. Customers can also ‘file’ payments when they are created or viewed in the transaction history. The systems of the exemplary embodiments provide a search function, enabling retrieval of documents based on a document storage time stamp, date last accessed, date posted, dollar amount, or by file folder, group, or category. Customers can view document access history. Further, the systems offer customers convenience, privacy, security and prevention of document loss from disaster, and protection from document or identity theft.

### BACKGROUND OF THE INVENTION

1. Field of the Invention

The present invention relates generally to techniques for electronically organizing financial information, and more particularly, to systems and methods for storing, creating, and organizing financial information electronically.

2. Description of the Related Art

In the United States of America, taxpayers are subject to audit by the U.S. Internal Revenue Service (IRS) for 7 years past their tax filing, and to respond to an audit, customers need access to payment and financial records. Conventionally, taxpayers store 7 years (or more) worth of payment records in file cabinets, shoe boxes, or other non-secure locations. With the advent of Internet banking, electronification of statements and check images, customers want to store these documents electronically. Attempts have been made to provide a secure storage for this type of information, eliminating the need for either paper copies of checks or a disaster recovery site for hard or soft copies of this information. However, such prior attempts have several limitations and drawbacks.

Some conventional electronic storage services focus on protecting private information, such as the eCogNito system available on the Internet at www.ecognito.net and the mylastwish.com service also available on the Internet. The eCogNito system secures private digital information to facilitate safe on-line purchases. In the eCogNito system, users register with eCogNito including the user's name, address, phone and credit card information. Once registered, users can shop at any eCogNito-enabled retailer anonymously. The mylastwish.com service is a website where users can store documents for their personal life, enabling them to review, edit, and add text, sound, pictures, video and web pages.

Other conventional systems provide on-line safe deposit boxes or document storage services. For example, FleetBoston Financial has FileTrust, an on-line document storage service that provides a secure online document repository. The FileTrust system allows users to store and manage important electronic documents and images such as contracts, deeds, titles, tax documents, and health records. Users can access and share documents using the Internet. Users can also view their billing information and history. Users can create a file system and share it with anyone they want. Users can designate guest access for viewing of specific files. The FileTrust system can add document certification, project management, and workflow-facilitation across businesses. Nevertheless, the FileTrust system is limited. Data cannot be linked across multiple accounts. Files cannot be given a hierarchy, data cannot be automatically filed, and payment aggregation cannot be carried out, for example.

Another example of an electronic storage service for financial information is New Century Bank. New Century Bank provides on-line storage for legal, banking or other personal data. Customers can share that information with their banks, lawyers, business partners, family or friends by simply giving them an access code. Users of the service can create files and then set sharing parameters for each document and designate them as either public or private. However, the New Century Bank system is limited. For example, it cannot link data across multiple accounts, give files a hierarchy, automatically file data, and aggregate payment information.

Yet another example of an electronic storage service for financial information is Zions Bank. Zions Bank provides a service called Z-Vault, which is an online document storage service, offering secure, long-term storage and management of critical or confidential e-documents and files. Like the FileTrust and New Century Bank systems, the Z-Vault cannot link data across multiple accounts, give files a hierarchy, automatically file data, and aggregate payment information.

Financial and banking institutions often include the ability for customers to get on-line statements within Internet banking applications. If customers want to copy, download, or save the statement for future reference, however, they have to save to a file on their computer hard drive. Some institutions may now (or in the future) include the ability to view, search, print, and save a check or deposit slip image. To save an image, customers can save the image to their computer hard drive. If the customer's computer is compromised (e.g., by hardware failure, data corruption, or theft), the customer would lose this confidential and private information, and if stolen, the payment information could be used for fraudulent purposes against the customer's account.

When customers need to retrieve historical payment information, they typically have a specific need to get confirmation that a payment was made, e.g., to respond to an audit, to resolve a dispute, to file income taxes. To facilitate this process, customers need to be able to store documents with multiple indicators, enabling a multi-dimensional search and retrieval.

Thus, there is a need to provide a convenient service to enable customers to store private and confidential financial information in a secure on-line electronic vault within an Internet banking application. Further, there is a need for customers to store financial information, including account statements, check images, deposit slip images, debit card or credit card electronic transactions in a safe, secure, and readily accessible fashion.

### SUMMARY OF THE INVENTION

Briefly summarized, an exemplary embodiment relates to an on-line financial information warehouse that offers customer driven aggregation of data, with the ability to dynamically modify the filing hierarchy, reside in a secure on-line environment, and allow customers to store, create and organize digital financial information. The exemplary embodiments enable customers to establish a hierarchy of file folders, including the ability to establish folders, categories, and groups, enabling multi-dimensional search capability, file any payment or other financial information whether paper or electronic in a folder for future reference, and provide secure storage for an indefinite period for any payment, including credit card payments, debit card transactions, imaged checks, electronic bill payments, account statements, or any other information that the customer wishes to store in the “vault.” As such, customers can create and change at will their file folder hierarchy. Customers can set a preference for automatic filing based on pre-established criteria such as folders based on standard merchant categories or by month. These multi-dimensional indicators enable customers to search and retrieve payment information based on any combination of search criteria, even though the data is stored in only one place in the warehouse.

Customers can also ‘file’ payments when they are created or viewed in the transaction history. The systems of the exemplary embodiments described herein provide a search function, enabling retrieval of documents based on a document storage time stamp, date last accessed, date posted, dollar amount, or by file folder, group, or category. Customers can view document access history. Further, the systems offer customers convenience, privacy, security and prevention of document loss from disaster, and protection from document or identity theft.

Alternative embodiments can include the ability for customers to store their own documents into the system for safe keeping, an electronic notary service, and the ability to store payment information from accounts at other financial institutions, using account aggregation.

One exemplary embodiment relates to a method of storing, creating, and organizing financial information electronically. The method includes establishing a communication session between a first system and a second system, communicating financial information from the second system to the first system corresponding to a first account, and associating the financial information with a folder, category, or group in the first system. The folder is one of a plurality of folders, categories, or groups being associated with each other in a hierarchical manner. The plurality of folders, categories, or groups are defined by a customer user associated with the first account.

Another exemplary embodiment relates to a system for storing, creating, and organizing financial information associated electronically. The system includes a host computer coupled to a network and running programmed instructions to provide reporting and folder operations and a customer user computer connectable to the network, the customer user computer communicating customer user information to the host computer. The host computer provides an on-line environment for a customer user to organize, send, search, create, and save financial information using a hierarchy of folders defined by the customer user. Each folder in the hierarchy of folders includes multiple indicators, whereby searches can be done across folders, categories, or groups.

### BRIEF DESCRIPTION OF DRAWINGS

FIG. 1 is a general block diagram depicting a banking information system in accordance with an exemplary embodiment.

FIG. 2 is a flow diagram depicting an overview of exemplary operations in the banking information system of FIG. 1.

FIG. 3 is a flow diagram depicting exemplary search and retrieve operations in the banking information system of FIG. 1.

FIG. 4 is a flow diagram depicting exemplary manage operations in the banking information system of FIG. 1.

FIG. 5 is a flow diagram depicting exemplary view and store operations in the banking information system of FIG. 1.

FIG. 6 is a flow diagram depicting exemplary access sharing operations in the banking information system of FIG. 1.

FIG. 7 is a flow diagram depicting exemplary reporting operations in the banking information system of FIG. 1.

FIG. 8 is a flow diagram depicting exemplary auto-file operations in the banking information system of FIG. 1.

FIG. 9 is a flow diagram depicting exemplary electronic notary operations in the banking information system of FIG. 1

FIG. 10 is a display depicting an exemplary user interface of the banking information system of FIG. 1.

FIG. 11 is a display depicting an exemplary file save user interface of the banking information system of FIG. 1.

FIGS. 12-13 are displays depicting exemplary finding documents user interfaces of the banking information system of FIG. 1.

FIGS. 14-16 are displays depicting exemplary user interfaces of the banking information system of FIG. 1.

### DETAILED DESCRIPTION OF EXEMPLARY EMBODIMENTS

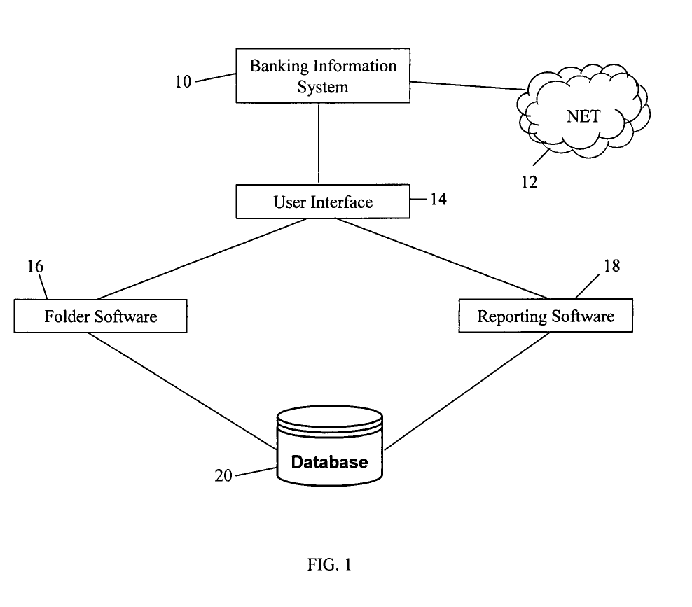

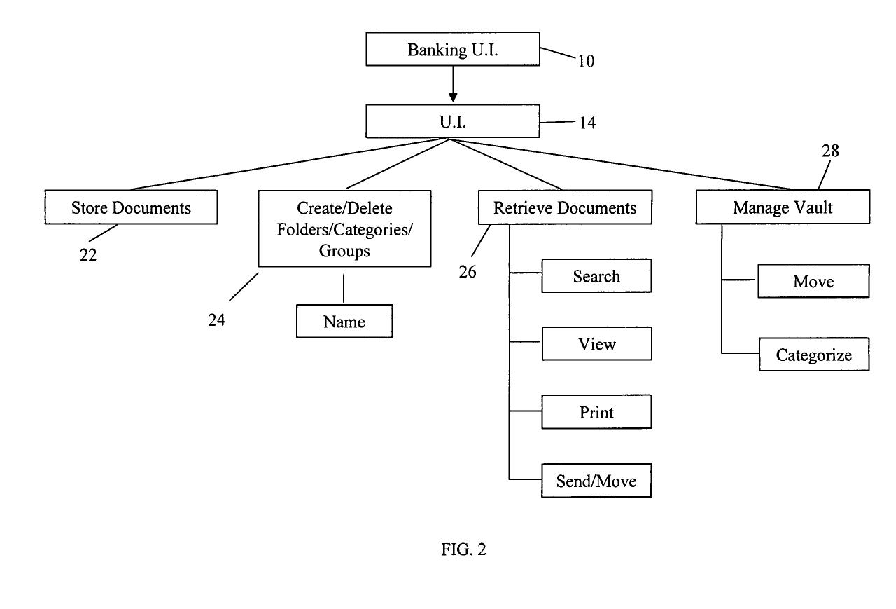

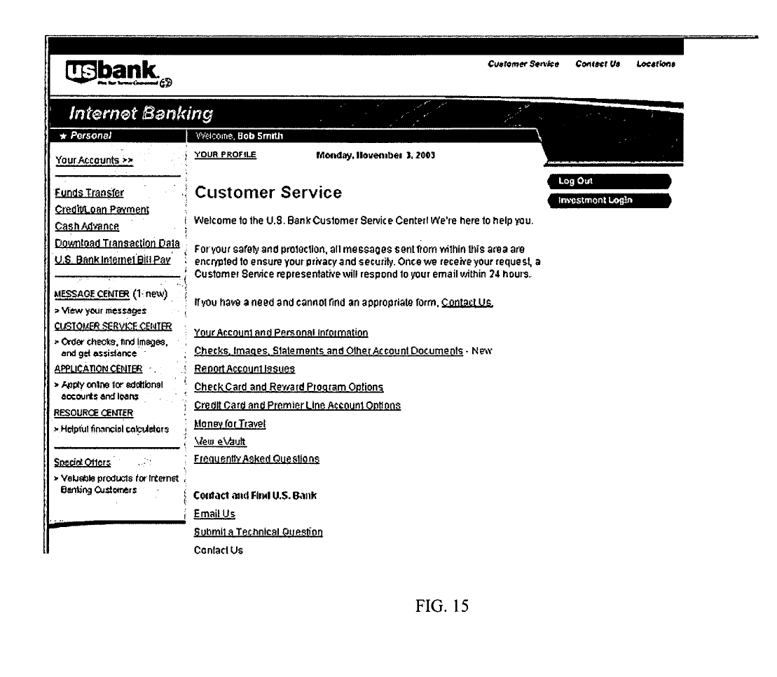

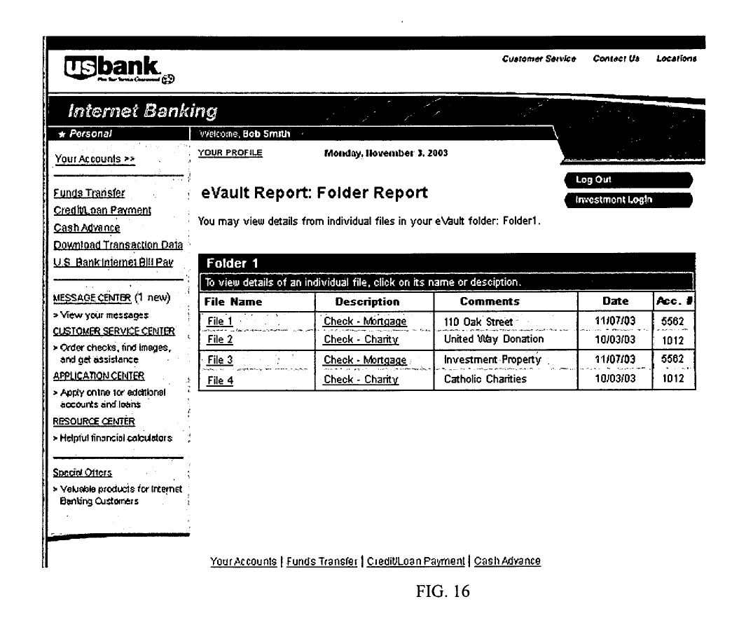

FIG. 1 illustrates a banking information system 10 which is connected to a network 12, such as the Internet. The banking information system 10 generally includes a user interface 14, a folder software 16, a reporting software 18, and a database 20. The folder software 16 and reporting software 18 perform various operations in the banking information system 10. Exemplary operations are described below with reference to FIGS. 2-16.

The banking information system 10 can be implemented as a software application written in JAVA, J2EE, or .net technology and supported on secured servers. The folder software 16 can include an administrative tool to assist users in managing customer folders in the banking information system 10. FIG. 1 shows the folder software 16 and reporting software 18 as separate software modules; however, in alternative embodiments, the folder software 16 and reporting software 18 are integrated into one software module.

FIG. 2 illustrates exemplary operations that can be performed in the banking information system 10 described with reference to FIG. 1. Additional, fewer, or different operations may be performed, depending on the embodiment. For example, the banking information system 10 can include a store documents operation 22, create or delete folders, categories, or groups operation 24, retrieve documents operation 26, and manage vault operation 28. Here, the term “vault” refers to the storage repository used in the banking information system 10. A variety of operations can be performed within each of these operations. For example, the create or delete folders operation 24 can include a naming operation. The retrieve documents operation 26 can include search, view, print, send, or move operations. The manage vault operation 28 can include move and categorize operations.

When a payment is filed, the banking information system 10 stores posting information (date, dollar amount, account number), item image (deposit slip, check or IRD), and information established by the customer (category, group, or comments/notes), date filed, dated last accessed, and entitlements. Customer users can also store any documents (e.g., Microsoft Word, Microsoft Excel, Microsoft Powerpoint, HTML, or Adobe Acrobat documents) in folders. This functionality provides a secure vault for copies of any document, including wills, deeds, birth certificates, social security cards, or digital photos.

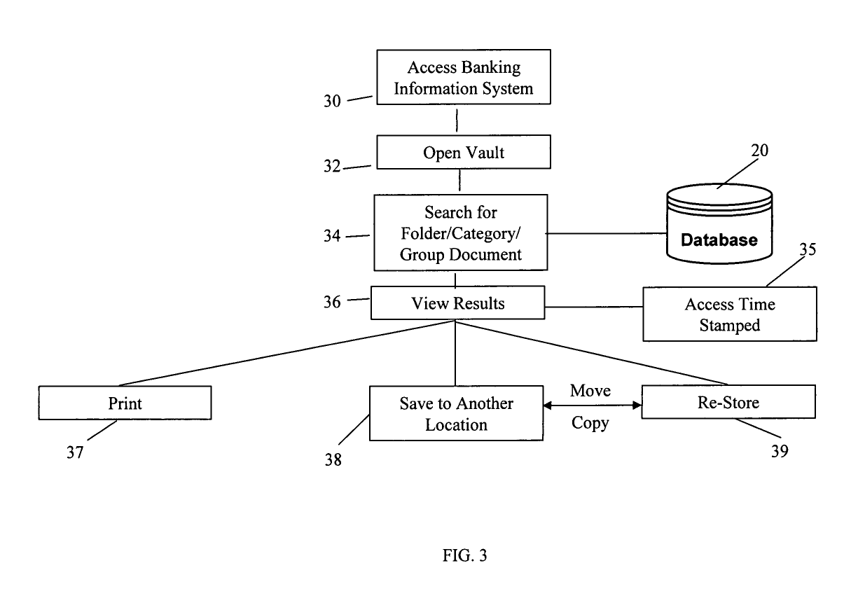

FIG. 3 illustrates a flow diagram of search and retrieve operations in the banking information system 10 described with reference to FIG. 1. Additional, fewer, or different operations may be performed, depending on the embodiment. In an operation 30, the banking information system 10 is accessed using, for example, an Internet-connected computer. In an operation 32, the vault is opened by the customer user. The customer user can open the vault by selecting an open vault operation from a user interface of the banking information system 10. Once the vault is open, the customer user can request an operation 34 in which the database 20 is searched for a specified folder, category, or group and/or document. In an operation 36, the results of the search are displayed. If a search result is viewed, an operation 35 is performed in which an access time stamp is applied such that a record is kept of access activity. The customer user can print one or more of the results (operation 37), save one or more of the results to another location (operation 38), or re-store one or more of the results (operation 39). Re-storing refers to moving or saving a document to a different folder.

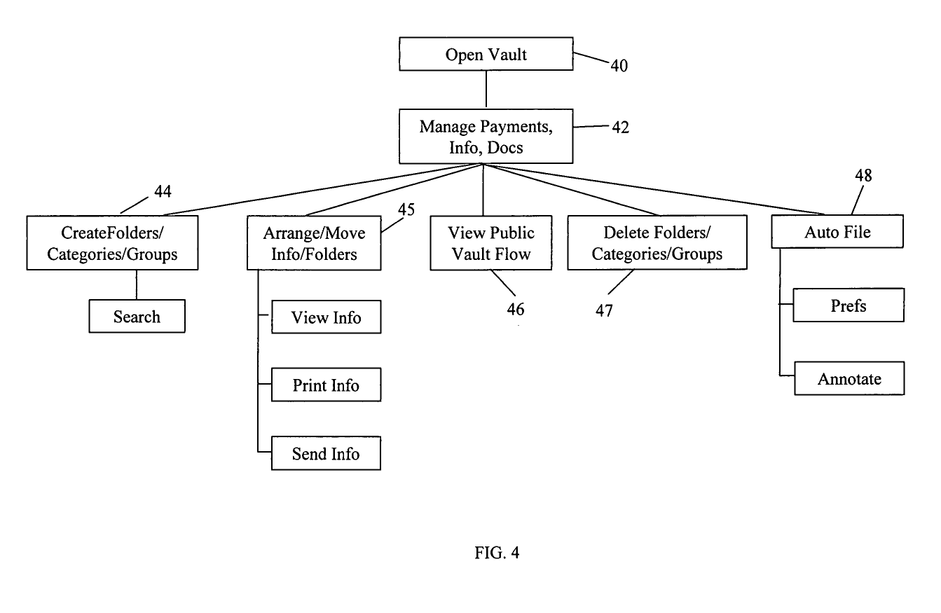

FIG. 4 illustrates a flow diagram depicting exemplary manage operations in the banking information system 10 of FIG. 1. Additional, fewer, or different operations may be performed, depending on the embodiment. In an operation 40, the vault is opened by the customer user which, as discussed, can occur from the banking information system 10 via a user interface. In an operation 42, the customer user can manage payments, information, and documents in the vault. Example management operations can include a create folders operation 44, an arrange/move information/folders operation 45, a view public vault flow operation 46, a delete folders operation 47, and an auto-file operation 48.

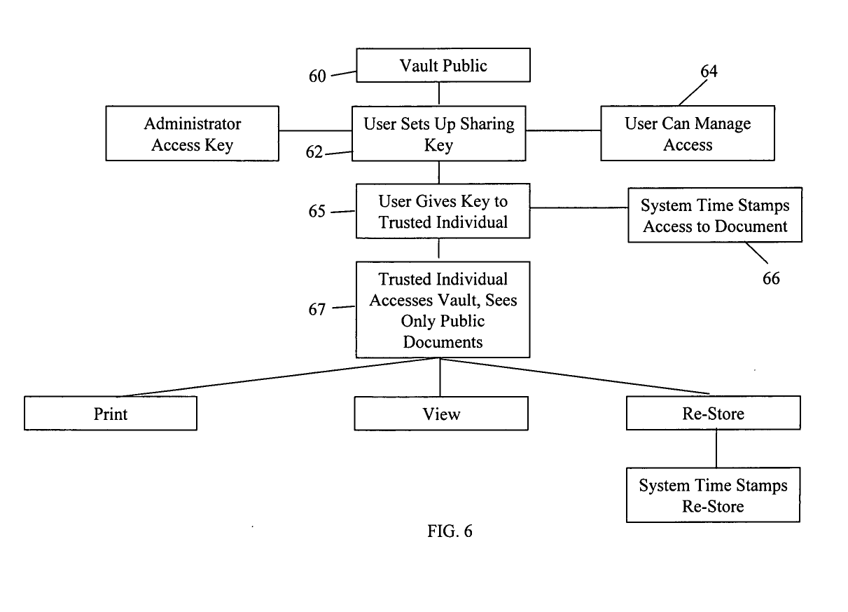

A variety of different operations can be performed within each operation. For example, the create folders operation 44 can include a search operation in which the customer can search for existing folders, categories, or groups. In the arrange/move information/folders operation 45, the customer user can view, print, or send (by e-mail, FTP, or otherwise) information. In the auto-file operation 48, the customer user can set preferences and annotations for the auto-filing of information and documents into folders. The view public vault flow operation 46 enables the account holder customer to view what activity exists with the folders, categories, or groups in the vault that can be accessed by others. The access of folders by people other than the account holder is described below with respect to FIG. 6.

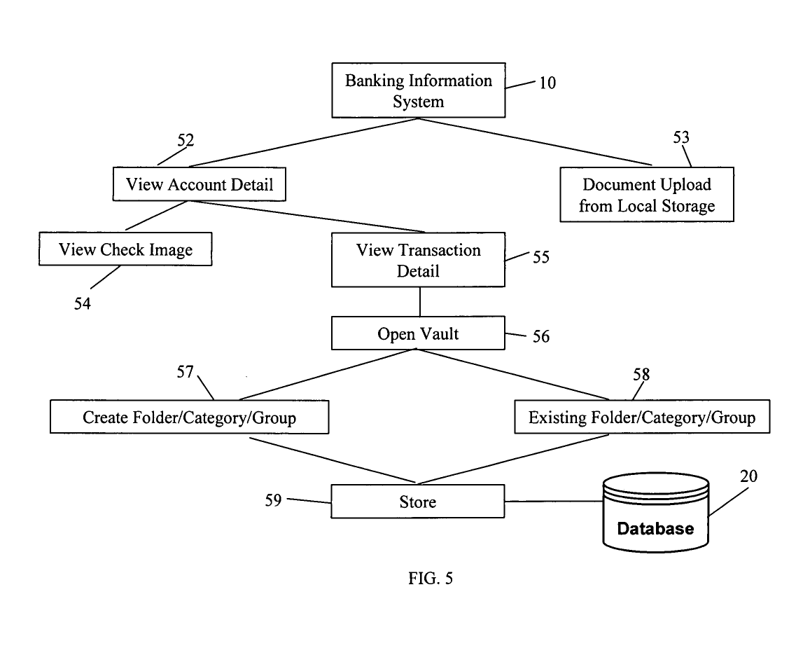

FIG. 5 illustrates a flow diagram depicting exemplary view and store operations in the banking information system 10 of FIG. 1. Additional, fewer, or different operations may be performed, depending on the embodiment. View and store operations can include a view account detail operation 52, upload document from local storage operation 53, view check image operation 54, view transaction detail operation 55, open vault operation 56, create folder, category, or group operation 57, identify existing folder operation 58, and store information operation 59. The upload document from local storage operation 53 can include obtaining information from a hard disk on the customers computer or some other storage medium, like a CD. Viewing operations, such as account detail operation 52, view check image operation 54, and view transaction detail operation 55 can include the open vault operation 56 and the create folder, category, or group operation 57 or identify existing folder operation 58, depending on whether the account detail or check image is located in an existing folder or needs a new one created.

FIG. 6 illustrates a flow diagram depicting exemplary access sharing operations in the banking information system 10 of FIG. 1. Additional, fewer, or different operations may be performed, depending on the embodiment. In an operation 60, the public vault is accessed by the customer user. The public vault can be accessed from a user interface in the banking information system 10. In an operation 62, the customer user sets up a sharing key. The sharing key allows individuals other than the customer user to access certain designated folders, categories, or groups within the vault of the banking information system 10. In operation 64, the customer user can manage access by, for example, determining which people get access to which folders, categories, or groups, whether such people have read only access or read and write access. The sharing key is different from an administrator key, which provides access to a trusted employee of the financial institution operating the banking information system 10 based on permission from the customer user.

In an operation 65, the customer user gives a sharing key to a trusted individual, like an accountant, tax lawyer, family member, or the such. In an operation 66, the banking information system 10 time stamps any access to documents by persons using the sharing key. When the trusted individual accesses the vault of the banking information system 10, he or she only sees documents that the customer user has designated as public. Depending on preferences set by the customer user, the trusted individuals may be able to print, view, and re-store documents. Re-store refers to moving a document to a different folder. If a re-store operation is performed, the system time stamps the document.

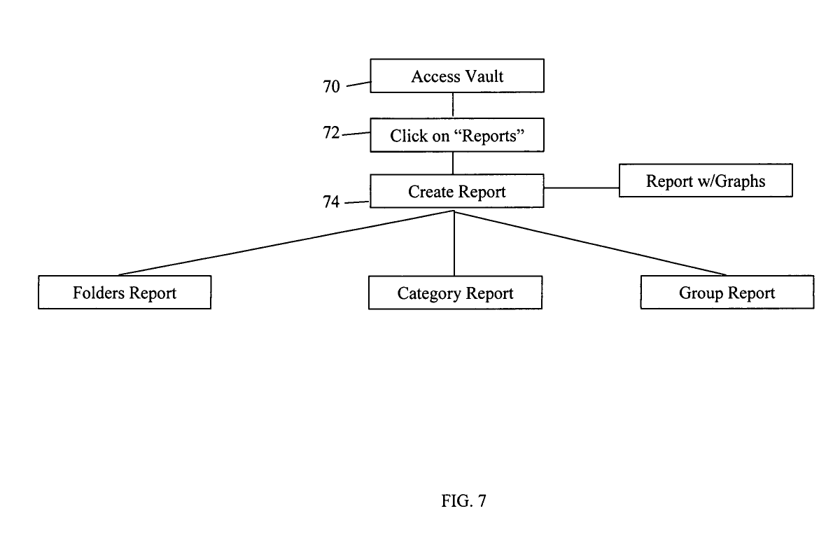

FIG. 7 illustrates a flow diagram depicting exemplary reporting operations in the banking information system 10 of FIG. 1. Additional, fewer, or different operations may be performed, depending on the embodiment. In an operation 70, the customer user accesses the vault in the banking information system 10. As described above, the customer user can access the vault using a user interface in the banking information system 10. In an operation 72, the customer user selects a report option by clicking on a hypermedia link. In an operation 74, a variety of different reports can be generated, such as a folders report, a category report, a group report, and a report with graphs. The reports are displayed and the customer user can print them. The customer user can select reports for any period of time, such as an annual report detailing categorized financial information over a calendar year. Other reports can be quarterly, monthly, etc.

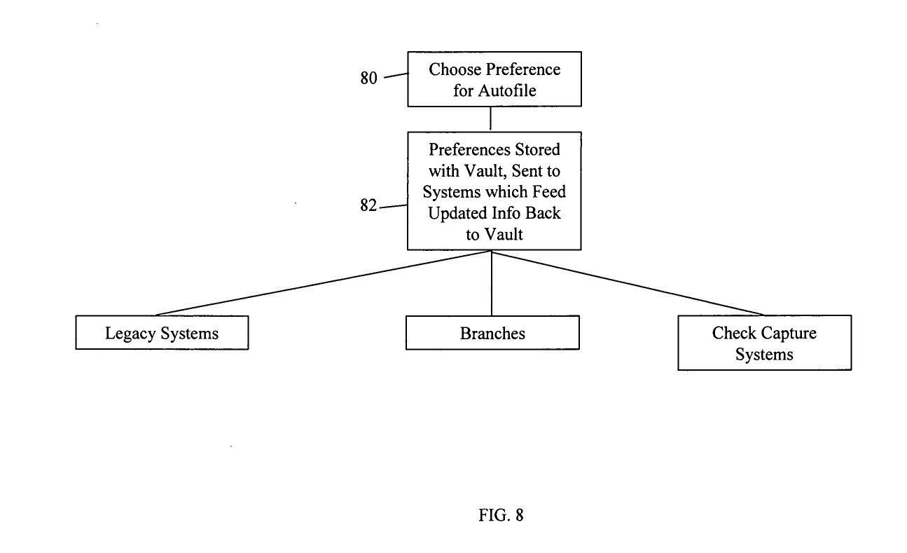

FIG. 8 illustrates a flow diagram depicting exemplary auto-file operations in the banking information system 10 of FIG. 1. Additional, fewer, or different operations may be performed, depending on the embodiment. In an operation 80, the customer user chooses preferences for the auto-filing feature. These preferences are stored in the vault of the banking information system 10, in an operation 82, and communicated to systems which feed updated information to the vault. For example, such systems can include mainframe, legacy systems that house deposit demand account (DDA), loan, or credit card information. Such systems can also include check capture systems and branches.

Sources for receiving information can include multiple financial institutions. By receiving updates from multiple financial institutions, the banking information system 10 is able to perform account aggregation whereby information from multiple sources can be combined, sorted, and organized together. For example, customer users can enroll other accounts they maintain at other financial institutions in the banking information system 10. As such, transaction data from these other financial institutions can be viewed from within the banking information system 10. Customer users can store this information in their information warehouse folders, indicating category, group and comment information in a manner similar to storing payment information associated with the “host” financial institution.

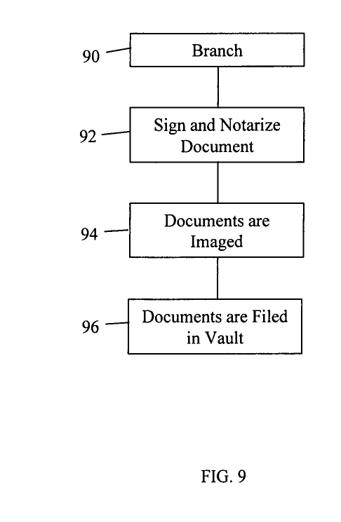

FIG. 9 illustrates a flow diagram depicting exemplary electronic notary operations in the banking information system 10 of FIG. 1. Additional, fewer, or different operations may be performed, depending on the embodiment. In an operation 90, a customer visits a branch office or a central office of the financial institution providing the banking information system 10. At the branch, the customer signs one or more documents and has it notarized in an operation 92. In general, a notary must sign a hardcopy of a document. However, the banking information system 10 would also allow for an electronic signature from a notary, if permitted by law and the financial institution. In an operation 94, the documents are imaged and, in an operation 94, documents are filed in the vault maintained by the banking information system 10.

Customers can print a ‘copy’ of documents in the vault from the banking information system 10 at any time. To receive an original with an embossed seal, the customer can visit any bank location, or request that the original be mailed to the account address. Hardcopy documents that are not notarized can also be stored in the banking information system 10. In other embodiments, for example, customers can file 1099 tax forms and interest earned/paid information in the folders of the banking information system 10.

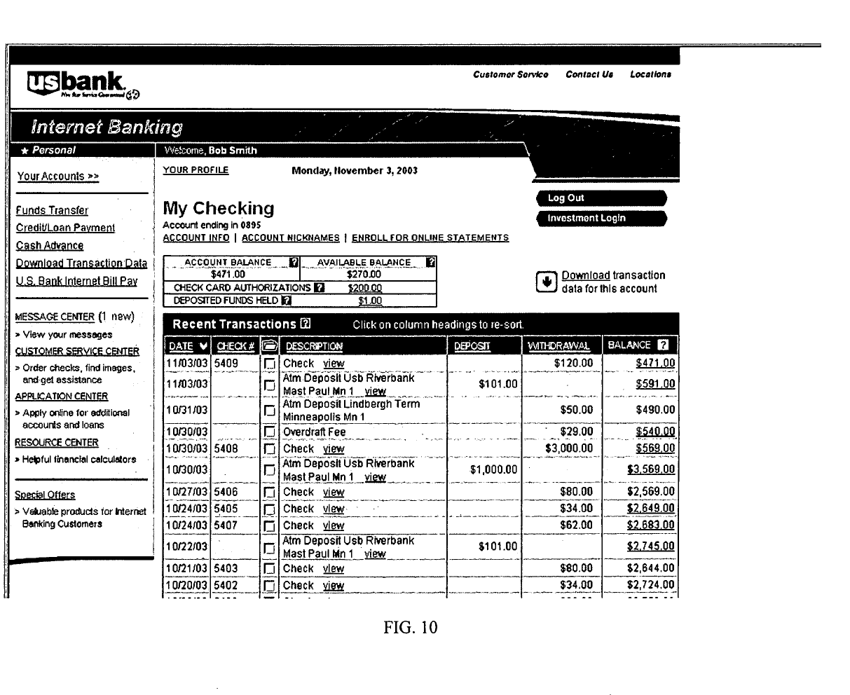

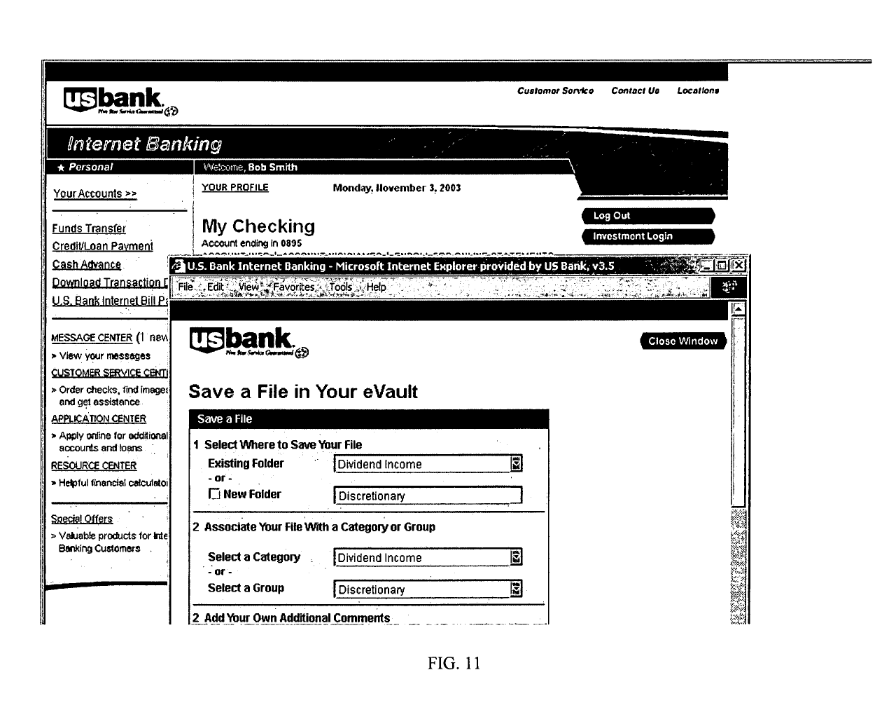

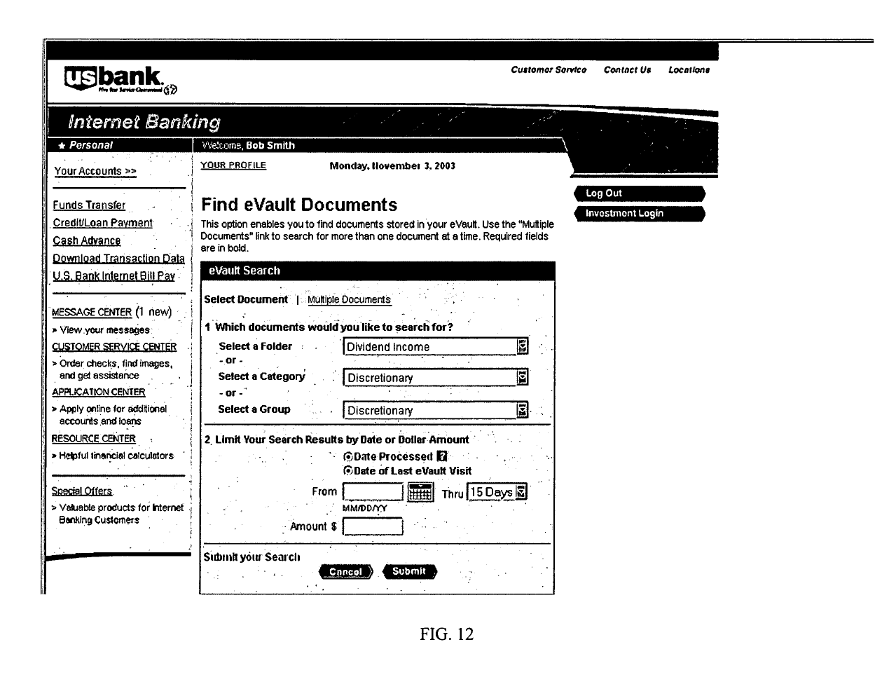

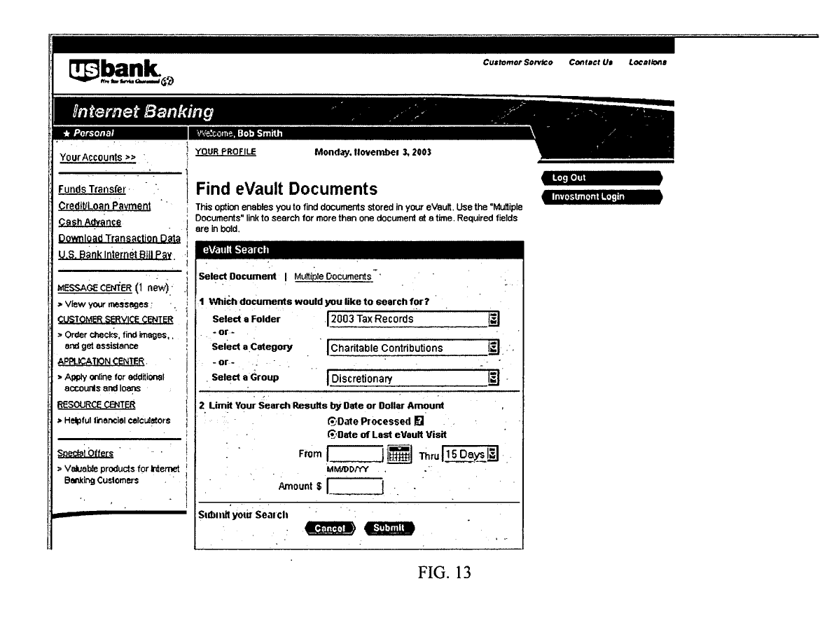

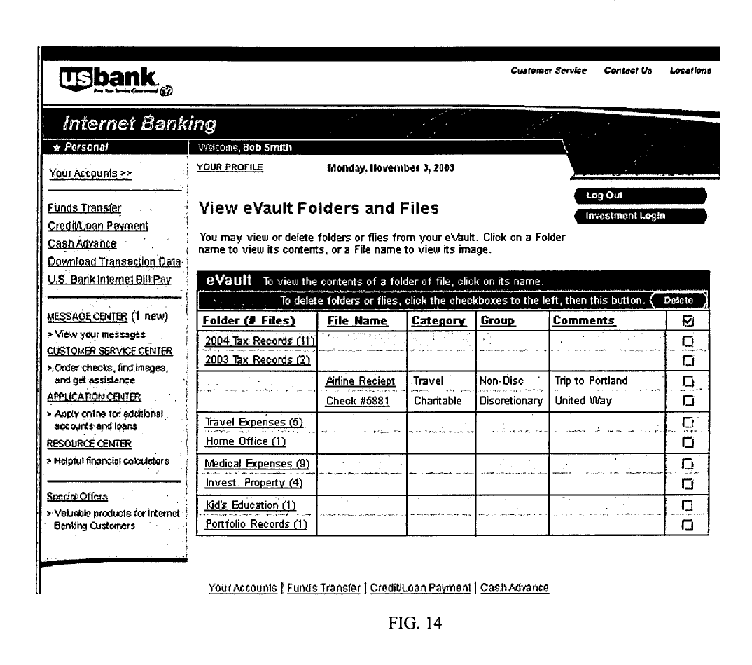

FIGS. 10-16 illustrate various displays depicting exemplary user interfaces of the banking information system 10 of FIG. 1. For example, FIG. 11 shows a user interface for a file save operation. FIGS. 12-13 show user interfaces for finding documents in the banking information system 10. FIGS. 14-16 show interfaces for other features of the banking information system 10.

The user interfaces display folders created by the customer user in which payment information can be stored. The customer can store payment information for any account (including credit cards, checking accounts, mortgages, etc.) in folders. From the transaction history file, customers can click ‘file’, and a pop-up user interface window asks which folder they want the document stored in. A preferences section allows customer users to establish a hierarchy of folders.

A “hierarchy of folders” refers to the structure and functionality that allows documents to be filed with multiple indicators, such that searches can be done across folders, categories, or groups. For example, if a category is “discretionary spending” and the customer user wants to pull up all items in all folders that are in the discretionary spending category, the folder hierarchy provides for that. Indeed, the folder hierarchy allows the customer user to search for items in different ways, such as searching across folders, or categories or groups.

Customers can click multiple items and request that they be stored in the same folder. Payments from multiple accounts at the same financial institution can be stored in the same folder.

The folders are configured such that customers can create and change their own file folder hierarchy. For example, within a “2003 Tax Records” folder, a customer might have 3 sub-folders: “Business Reimbursable Expense”, “Home Office Records” and “Charitable Contributions Records.” Customers can change and modify (e.g., rename, move, delete) the folder hierarchy at any time.

In an exemplary embodiment, when a document is filed, customers can select a category, group and can enter free form comments. For example, in a “2003 Travel” folder, categories might be set for ‘Airline’, ‘Hotel’ and ‘Meals’. Comments might be used to note the business purpose of the travel.

Within the preferences section, customers can select ‘auto file’ as an option. For credit card or debit card payments, customers can opt to use standard merchant categories (e.g., airline, hotel, gas, etc.), automatically filing those payments to the appropriate folder. Or, customers can opt to automatically file all payments by month to a folder. For example, as a standard option, customers can file all checking account payments processed in January 2004 to a folder titled ‘January 2004 Checking payments’.

In an exemplary embodiment, when a document is filed, customers can select a category, group and can enter free form comments. For example, in a “2003 Travel” folder, categories might be set for ‘Airline’, ‘Hotel’ and ‘Meals’. Comments might be used to note the business purpose of the travel.

As discussed above, customer users can search the banking information system 10 for payments or statements in a multi-dimensional way, e.g., by folder, across multiple folders, by group or by category. The documents are dated for the date they were stored and accessed to further enhance security. Customers can search based on check number, posting date, dollar amount, payee (if available), date filed, date last accessed, by file folder, or across file folders, by category or group. An online charting function enables customers to view pie charts and bar graphs comparing payments by category or file folder. Customers can opt to file their annual payment summary directly into a selected folder. Customers can also provide “nicknames” for items so that they can be searched via the nickname or item name.

While several embodiments of the invention have been described, it is to be understood that modifications and changes will occur to those skilled in the art to which the invention pertains. For example, although the term “banking” is used to describe the banking information system 10, the system is not limited to operation by a bank or credit union. Any entity could provide the banking information system 10. Accordingly, the claims appended to this specification are intended to define the invention precisely.

1. A method of storing, creating, and organizing financial information electronically, the method comprising:
establishing a communication session between a first system and a second system;
communicating financial information from the second system to the first system corresponding to a first account; and
associating the financial information with a folder, category, or group in the first system, the folder being one of a plurality of folders being associated with each other in a hierarchical manner, wherein the plurality of folders are defined by a customer user associated with the first account.

2. The method of claim 1, wherein the financial information includes credit card payments, debit card transactions, imaged checks, electronic bill payments or account statements.

3. The method of claim 1, wherein associating the financial information with a folder in the first system comprises filing the financial information into the folder based on instructions from the customer user when the financial information is viewed.

4. The method of claim 1, wherein associating the financial information with a folder in the first system comprises automatically associating the financial information with a folder upon receipt without human intervention.

5. The method of claim 4, wherein automatic filing is based on pre-established criteria.

6. The method of claim 5, wherein the pre-established criteria includes merchant categories.

7. The method of claim 1, further comprising retrieving documents based on a document storage time stamp, date last accessed, date posted, dollar amount, or by file folder, group, or category.

8. The method of claim 1, further comprising communicating financial information from a third system to the first system corresponding to the first account, wherein the third system and the second system contain separate and distinct accounts associated with the customer user.

9. The method of claim 1, further comprising providing each of the plurality of folders with a public or private indication, the folders indicated as public being accessible by persons having a shared key given them by the customer user.

10. A system for storing, creating, and organizing financial information associated electronically, the system comprising:
a host computer coupled to a network and running programmed instructions to provide reporting and folder operations; and
a customer user computer connectable to the network, the customer user computer communicating customer user information to the host computer;
wherein the host computer provides an on-line environment for a customer user to organize, send, search, create, and save financial information using a hierarchy of folders defined by the customer user, further wherein each folder in the hierarchy of folders includes multiple indicators, whereby searches can be done across folders.

11. The system of claim 10, wherein the financial information includes credit card payments, debit card transactions, imaged checks, electronic bill payments or account statements.

12. The system of claim 10, wherein financial information is associated with a folder based on instructions from the customer user when the financial information is viewed.

13. The system of claim 10, wherein financial information is associated with a folder automatically upon receipt based on user-defined criteria.

14. The system of claim 10, wherein the multiple indicators include document storage time stamp, date last accessed, date posted, dollar amount, or by file folder, group, or category.

15. A system of storing, creating, and organizing financial information electronically, the system comprising:
means for establishing a communication session between a first system and a second system;
means for communicating financial information from the second system to the first system corresponding to an first account; and
means for associating the financial information with a folder, category, or group in the first computer, the folder, category, or group being one of a plurality of folders, categories or groups being associated with each other in a hierarchical manner, wherein the plurality of folders, categories or groups are defined by a customer user associated with the first account.

16. The system of claim 15, wherein the associations of the plurality of folders, categories, or groups can be dynamically modified by the customer user.

17. The system of claim 15, further comprising means for conducting a multi-dimensional search of the plurality of folders, categories or groups.

18. The system of claim 17, wherein the multi-dimensional search searches financial information in the plurality of folders, categories or groups based on multi-dimensional indicators, whereby the customer user can search and retrieve financial information based on any combination of search criteria.

19. The system of claim 15, wherein the associations of the financial information with one or more folders in the plurality of folders, categories or groups are made when the first computer receives the financial information.

20. The system of claim 15, wherein the associations of the financial information with one or more folders in the plurality of folders, categories or groups are made at the instruction of the customer user.

21. The system of claim 15, further comprising means for storing financial information from accounts at other financial institutions not associated with the first system or the second system.

22. The system of claim 15, further comprising means to store electronic copies of scanned documents.

23. The system of claim 22, wherein the scanned documents include notarized documents.

24. The system of claim 22, wherein the scanned documents include imaged checks.

25. The system of claim 15, further comprising means for creating entitlements to share access to designated folders and documents.
